(19) United States
(12) Patent Application Publication
(10) Pub. No.: US 2008/0147456 A1
(43) Pub. Date: Jun. 19, 2008

(54) Methods of detecting and avoiding fraudulent internet-based advertisement viewings

(76) Inventors: Andrei Zary Broder, Menlo Park, CA (US); Boris Klots, Belmont, CA (US)

Correspondence Address: STATTLER - SUH PC, 60 SOUTH MARKET STREET, SUITE 480, SAN JOSE, CA, 95113, US

(21) Appl. No.: 11/642,098

(22) Filed: Dec. 19, 2006

(51) Int. Cl. G06F 9/44

(52) U.S. Cl. 705/7

(57) ABSTRACT

Non human entities such as automated web crawlers or malicious click-fraud programs can skew the tracking of clicks on web site advertisements. Thus, it is desirable to filter out page views caused by such automated entities. To achieve this goal, a web site may interject an intermediate web page after a web viewer selects an advertising link but before the web viewer is sent to the advertiser's designated web site. The intermediate web page allows for a response from the web viewer. The system then analyzes the web viewer's response to the intermediate web page (if any) along with other information using an adjustable testing policy to make a determination as to whether the web viewer is a human or non-human entity. An adjustable interject policy may be used to determine if an interjection should occur after a web viewer has selected an advertisement and before the web viewer is directed to the advertiser's designated web site. In this manner, the number of web viewers that are subjected to the intermediate web page is reduced.

### FIELD OF THE INVENTION

The present invention relates to the field of Internet advertising systems. In particular the present invention discloses techniques for determining if World Wide Web traffic is from a human viewer or a non-human entity such as a web crawler.

### BACKGROUND OF THE INVENTION

The global Internet has become a mass media on par with radio and television. And just like radio content and television content, Internet content is largely supported by advertising that is interspersed within the content. Two of the most common types of advertisements on the Internet are banner advertisements and text link advertisements. Banner advertisements are generally images or animations that are displayed within an Internet web page. Text link advertisements are generally short segments of text that are linked to the advertiser's web site.

With any advertising-supported business model, there needs to be some metrics for assigning monetary value to the advertising. Radio stations and television stations use ratings services that assess how many people are listening to a particular radio program or watching a particular television program in order to assign a monetary value to advertising on that particular program. Radio and television programs with more listeners or watchers are assigned larger monetary values for advertising. With Internet banner type advertisements, a similar metric may be used. For example, the metric may be the number of times that a particular Internet banner advertisement is displayed to people browsing various web sites.

However, with text link advertisements, there is not much value in simply displaying the short text segment to the web viewers. With text link advertisements, the advertiser is most concerned with having web viewers select the text link advertisement in order to be directed to the advertiser's full web site. When a web viewer selects an advertisement, this is known as a ‘click through’ since the web viewer ‘clicks through’ the text link to see the advertiser's web site. A click-through clearly has value to the advertiser since an interested web viewer has indicated a desire to see the advertiser's web site and is presented with the advertiser's web site.

Many advertising-supported web sites pride themselves on their ability to display the most appropriate advertisements to web viewers. These advertising supported web sites use search queries and matching algorithms to select the advertisements that match the web viewer's current or past browsing habits. Due to this ability, many advertising-supported web sites have offered to sell advertising on a pay-per-click basis wherein the advertising-supported web site is only paid when a web viewer clicks on a displayed advertisement.

There are many non-human entities that browse the World Wide Web. For example, search engines use ‘web crawlers’ to explore the Internet and learn about the available web sites. This information is used to create indexing systems that provide the ability to quickly search for web sites using keyword searches. Similarly, network management software may test web servers by sending web site requests in order to monitor the health and performance of web servers. Since these types of clicks are of different kind than what advertisers desire. Ideally, such non human web site traffic should be marked as such and this classification should be taken into account when billing the advertisers.

In even more unpleasant scenarios, malicious computer programs may be created in order to repeatedly access advertising-supported links to intentionally create the false appearance of many web site visits by human web viewers. For example, a malicious business competitor may create a program that repeatedly accesses his competitor's advertising web links in order to generate large advertising charges that will harm his competition. Such intentional attempts to create fictitious web site traffic on advertising-supported sites are known as ‘click spam’.

Similarly, a web site publisher may create a program that clicks on the advertisements displayed on his own web site in order to collect advertising fees for those false clicks. Such attempts to create fictitious web site traffic in order to collect advertising fees are known as ‘click fraud’. Click fraud can cause erroneous charges to web site advertisers. Click spam and click fraud threatens destroy the trust between web site advertisers and web site content publishers and might challenge the integrity of the pay-per-click advertising market.

Due to the corrosive effects of click spam and click fraud, it would be desirable to find methods of detecting and preventing click spam and click fraud. Ideally, such a click spam and click fraud detection system would determine whether an access request to an advertising supported link represented a legitimate human viewer or a software program that is automatically accessing the advertising supported link (possibly with the malicious intent of creating fictitious traffic).

### SUMMARY OF THE INVENTION

The present invention introduces methods for determining if web viewers that select advertising supported links are humans or non-human entities such as computer programs that browse the web. The system of the present invention interjects an intermediate web page after a viewer selects an advertising link but before the web viewer is sent to the advertiser's designated web site. The intermediate web page allows for a response from the web viewer. The system then analyzes the web viewer's response to the intermediate web page (if any) along with other information using an adjustable testing policy to make a determination as to whether the web viewer is a human or non-human entity.

In one embodiment of the present invention, the system evaluates an adjustable interject policy that determines if an interjection should occur after a web viewer has selected an advertisement and before the web viewer is directed to the advertiser's designated web site. In this manner, the number of web viewers that are subjected to the intermediate web page is reduced.

Other objects, features, and advantages of present invention will be apparent from the accompanying drawings and from the following detailed description.

### BRIEF DESCRIPTION OF THE DRAWINGS

The objects, features, and advantages of the present invention will be apparent to one skilled in the art, in view of the following detailed description in which:

FIG. 1 illustrates a flow diagram of the typical process of having a web viewer access an advertising supported link.

FIG. 2 illustrates the flow diagram of FIG. 1 wherein the system interjects an intermediate web page after a web viewer has selected an advertising supported link and analyzes the viewer's response to that intermediate web page.

FIG. 3A illustrates an example embodiment of a simple intermediate web page with a welcome message image that contains a specific area to click to continue.

FIG. 3B illustrates the simple intermediate web page of FIG. 3A wherein the specific area to click within the welcome message image to continue has been moved.

FIG. 4A illustrates an example embodiment of an intermediate web page that requests demographic information from the web viewer.

FIG. 4B illustrates an example embodiment of an intermediate web page that requests the web viewer to provide specific interest information by selecting an area on the display screen.

FIG. 4C illustrates the intermediate web page of FIG. 4B wherein the area on the display screen for the viewer to specify specific interest information has been moved.

FIG. 5 illustrates an example embodiment of an intermediate web page that illustrates on example of a Completely Automated Public Turing test to tell Computers and Humans Apart (CAPTCHA).

FIG. 6 illustrates the flow diagram of FIG. 2 wherein the system evaluates an interject policy to determine if the system should interject an intermediate web page after the web viewer has selected an advertising supported link.

### DETAILED DESCRIPTION

Methods and apparatuses for avoiding fraudulent Internet-based advertisement viewings are disclosed. In the following description, for purposes of explanation, specific nomenclature is set forth to provide a thorough understanding of the present invention. However, it will be apparent to one skilled in the art that these specific details are not required in order to practice the present invention. Similarly, although the present invention is mainly described with reference to the World Wide Web and the HyperText Transport Protocol (HTTP), the same techniques can easily be applied to other types of Internet advertising.

### Advertising Supported World Wide Web Sites

The global Internet has become a mass media that largely operates using advertiser supported web sites. Specifically, publishers provide interesting content that attracts web viewers. To compensate the publisher for creating the interesting web site content, the publisher intersperses paid advertisements into the web pages. Some Internet web site advertisements are banner advertisements that consist of an advertiser-supplied image or animation that is displayed to the viewer of the web page. Other Internet web site advertisements are text link advertisements that are generally short segments of text that are linked to the advertiser's web site.

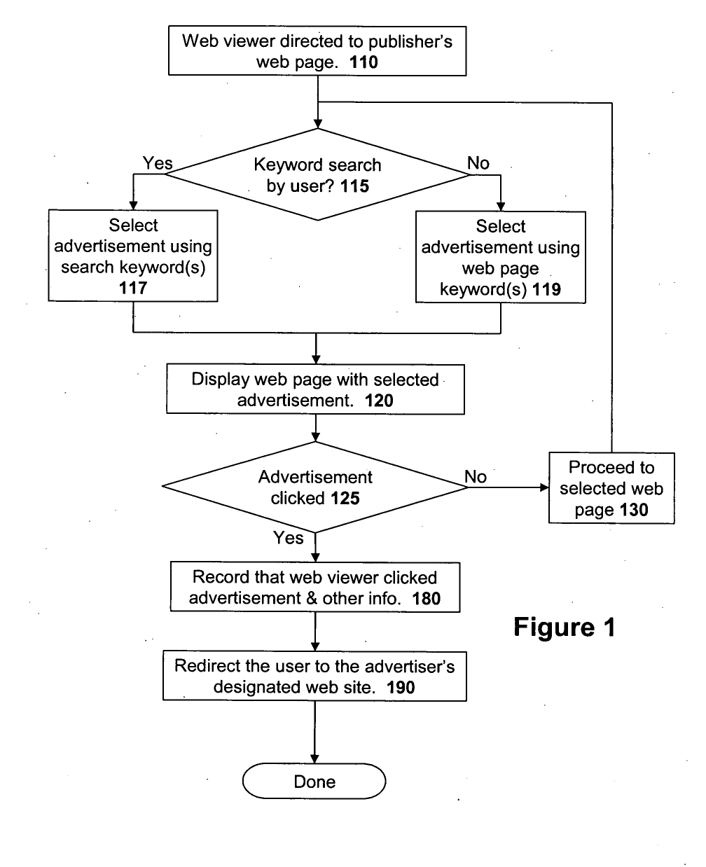

FIG. 1 illustrates a flow diagram that describes a typical process of displaying and handling Internet web site advertisements. In the example of FIG. 1 there are four parties involved: a web page publisher that publishes interesting web content, an advertising network that provides advertisements for supporting the web publisher, and advertisers that pay for advertisements, and the web viewer that views the published we pages. Note that some of these parties may be the same entity. For example, an advertising network may also provide its own web content and thus also be the web publisher.

Referring to FIG. 1, the web viewer is directed to a web publisher's site at step 110. At step 115, the system determines if the web viewer was directed to the web page using a search keyword or not. If the web viewer was directed to the web page using a keyword search then the advertising network may select an advertisement using one or more keywords from the web viewer's search as set forth in step 117. If the web viewer was directed to the web page by some means other than a keyword search, then the advertising network may select an advertisement using one or more keywords from the web page as set forth in step 119. The web publisher then delivers the web page with the selected advertisement to the web viewer's web browser for display as set forth in step 120.

If the web viewer does not click on a displayed advertisement at step 125, then the system proceeds to the web page selected by the web viewer as set forth in step 130. If the web viewer does click on a displayed advertisement at step 125, then the advertising network records the web viewer's advertisement selection (in order to charge the advertiser for the click-through) along with other available information at step at step 180. The other available information that may be recorded can include ‘cookie’ information (information provide by the web viewer's web browser), the web viewer's Internet Protocol (IP) address, and any other information known about the web viewer. That recorded information may be used in deciding to charge the advertiser for the advertisement. The web viewer's web browser is then re-directed to access the advertiser's designated web site at step 190. At this point, the advertiser has obtained the full attention of a potential customer.

As set forth in the background, there are many non-human entities that browse Internet web sites for a variety of reasons. In the worst cases, an automated program may be intentionally trying to create fictitious web site traffic solely for the reason of creating advertising charges for the advertiser. In order to prevent this type of abuse of Internet advertising services, it would be very desirable to be able to detect and possibly prevent such fictitious web site traffic.

### Intermediate Pages for Click Fraud Testing

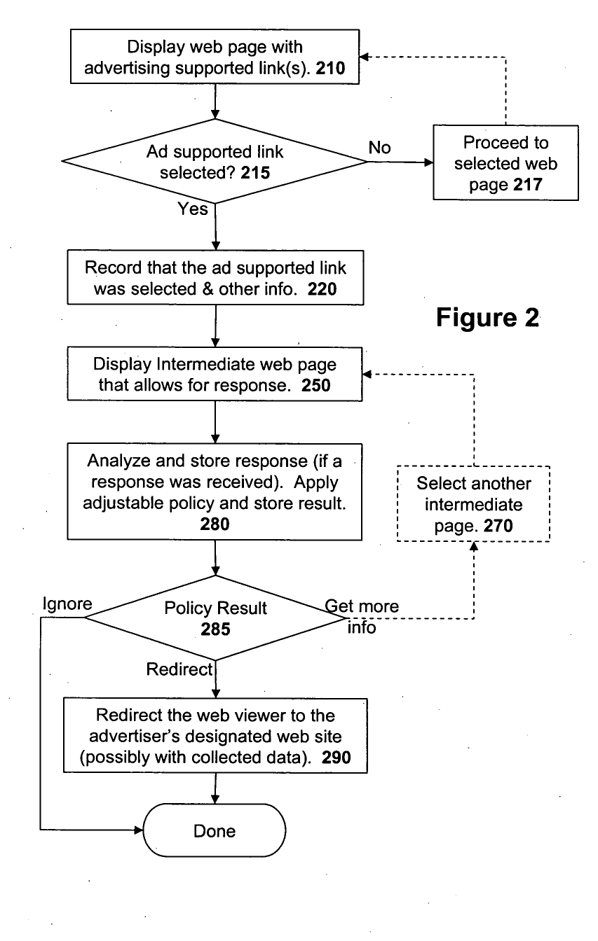

To test for and reduce non human web site traffic, the present invention proposes interjecting an intermediate web page between the display of the original web page wherein the advertisement was selected by the web viewer and the advertiser's designated web page. The intermediate page may take many different forms and may be used to help determine if the entity that selected the advertisement link was a human or a non human entity. FIG. 2 illustrates one embodiment incorporating the teachings of the present invention.

Referring to FIG. 2, the initial steps are similar to FIG. 1. Initially, an advertising supported web page is displayed to a web viewer at step 210. (The process of selecting the advertisement has been omitted for clarity). The system then processes the web viewers input at step 215. Specifically, if no advertisement is selected, then the web viewer is directed to the web viewer's selected web page as set forth in step 217. If the user selects an advertisement, then the advertising network records the advertisement selection and other information at step 220). But at this point, the system behaves in a different manner.

After the advertising network records that an advertisement supported link has been selected, the system proceeds to step 250 wherein the system displays an intermediate web page. The intermediate web page may be provided by the web publisher, the advertising network, or the advertiser.

The content of the intermediate web page may vary widely depending on the circumstances. The intermediate page may be anything from a simple ‘Welcome’ web page to a web page that requires the web viewer to complete a complex task that would prove that the web viewer is a human. The following sections set forth a number of examples of possible intermediate pages that may be employed. This list is not exhaustive, it is merely meant to show some of the possibilities of intermediate web pages that may be used.

### Simple Welcome Page

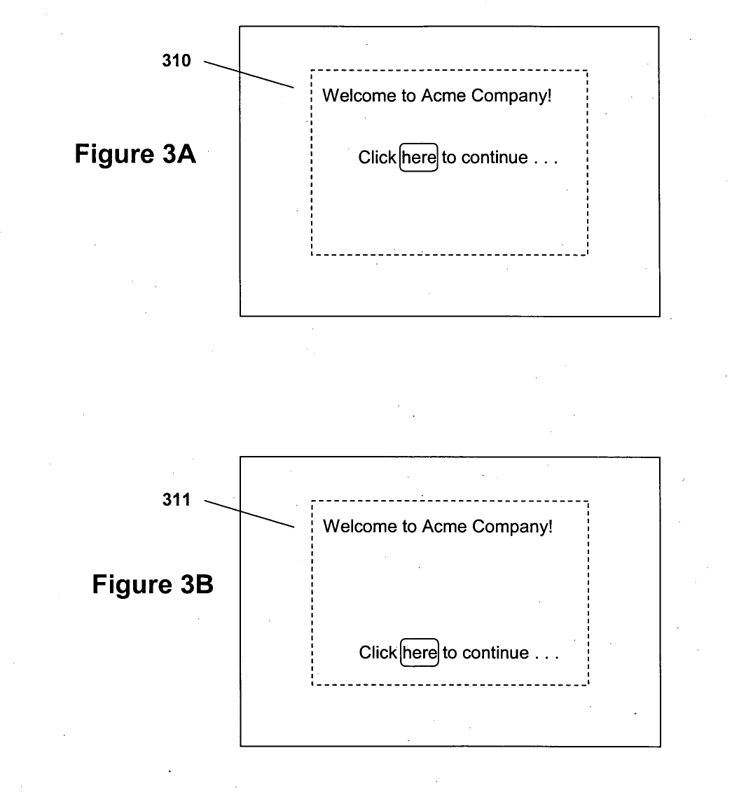

FIG. 3A illustrates an example embodiment of a simple welcome page that may be used as an intermediate page. As illustrated in FIG. 3A, the simple welcome page merely displays a short welcome message. In one embodiment, the welcome page has a watch-dog timer that displays the welcome page for short period before automatically transferring the web viewer to the advertiser's full web site. As illustrated in FIG. 3A, the welcome page may include an area for the web viewer to click to proceed to the advertiser's fill web site without waiting for the time-out timer to expire.

### Welcome Page with Variable-Click Location

An alternative to the simple welcome page is a welcome web page with a variable click location. In such an embodiment, a welcome web page requires a web viewer to click a specified location on the welcome web page as illustrated in FIG. 3A. The welcome web page may implement the specified click location with an image 310. However, the location of where the web viewer must click within the displayed image may be in a different location each time a web viewer accesses the web site. For example, FIG. 3B illustrates the same welcome page as in FIG. 3A except that the location wherein the web viewer must click within the displayed image to proceed has been moved to a different location on the web viewer's display screen. In this manner, a non human entity (such as a web crawler) would have difficulty in determining where to click on the screen.

In a preferred embodiment, the name of the image files used to display the welcome message would change such that a non human entity could not associate a particular image file name with a particular location that must be clicked within the image for that image file. This can be performed by generating random file names for the image files. In an alternate embodiment, the system could use the same file names but change the required click location within the displayed image in a time dependent fashion (e.g. every 15 seconds) and build an appropriate protocol that requires a correct click within a short period of time after presentation.

### Data Collection Intermediate Page

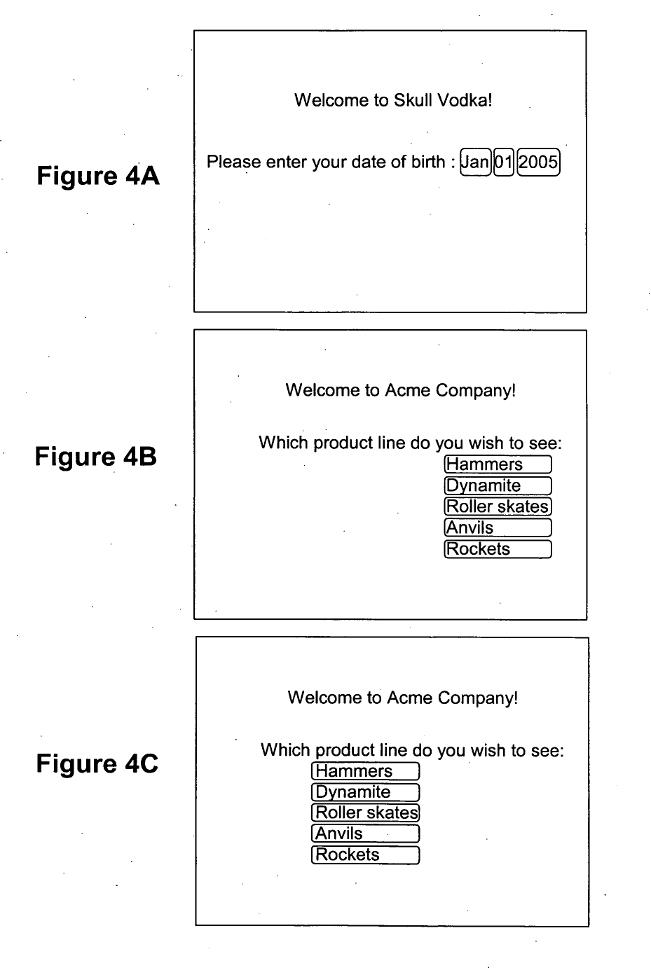

A more complex intermediate page may require more interaction from the web viewer. For example, an intermediate page may require the collection of certain demographic information from the web viewer. FIG. 4A illustrates an example intermediate page that requires the web viewer to enter a date of birth. Such an intermediate page may be useful for advertisers associated with products for adults only such as alcohol and tobacco products. Any other type of demographic information may be requested from the web viewer such as the web viewer's sex, ZIP code, country of origin, etc.

In addition to demographic data, any other type of data may be collected from the web viewer. The information collected from the web viewer may be used to improve the web viewer's browsing experience at the web site. For example, FIG. 4B illustrates an intermediate page that requests the web viewer to select a specific product line that the web viewer wishes to view. In this manner, the intermediate web page may be used to direct the web viewer to most appropriate page for the web viewer's specific needs.

The collection of data may be combined with the variable click location within an image technique set forth in the previous section. For example, FIG. 4C illustrates the data collection intermediate page of FIG. 4B except that the location of the product line choices has been moved. In this manner, a non human entity cannot be easily programmed to always click the proper location within the displayed image.

### Difficult Task Page (CAPTCHA)

In an extreme example of an intermediate page, a CAPTCHA page may be used. A CAPTCHA (Completely Automated Public Turing test to tell Computers and Humans Apart, AKA CAPTCHA) is a challenge-response test used to determine whether or not the web viewer is human. With a CAPTCHA intermediate page, the ability to determine whether a particular web viewer is a human or a non human entity is greatly simplified.

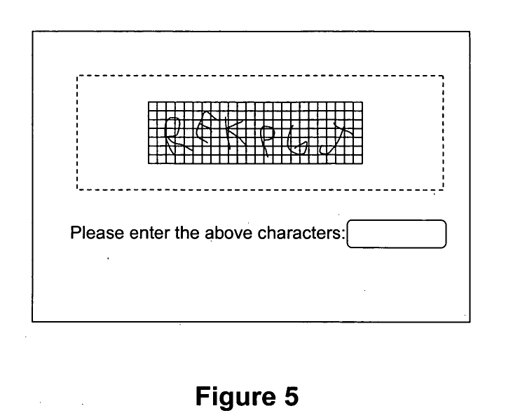

A well known type of CAPTCHA requires that the web viewer to view a distorted image and then type in the letters and numbers displayed in the distorted image. The distorted image generally comprises an obscured sequence of distorted letters and/or digits that are camouflaged with additional lines. For example, FIG. 5 illustrates an intermediate web page containing one embodiment of CAPTCHA that requires the entry of letters and/or digits displayed in a distorted image. Additional information on CAPTCHAs can be found in U.S. Pat. No. 6,195,698 entitled “Method for selectively restricting access to computer systems” issued on Feb. 27, 2001, that is hereby incorporated by reference.

Although a CAPTCHA intermediate web page presents the best system for determining if a web viewer is a human or non human entity, this method should be avoided in most situations since the annoyance of having to complete a CAPTCHA task will tend to drive many web viewers away. Annoying web viewers that may be potential customers is clearly not the goal of a web advertiser. However, if it seems that a web site is being attacked by a malicious robot program, that web site may elect to use a CAPTCHA intermediate page in order to filter out all of the accesses by the malicious robot program.

Referring back to the flow diagram of FIG. 2, after displaying the intermediate web page at step 250, the system then stores and analyzes the web viewer's response to the intermediate page (if any response was received from the web viewer) at step 280. An adjustable policy is then applied to determine whether the web viewer is a human or not and how the system should proceed.

The adjustable policy may consider a large number of different factors depending on what information is collected from the web viewer and the desires of the advertiser. The following is a list of factors that may be considered and possibly manners to consider these factors. However, this list is not exhaustive as other additional factors may be considered with an adjustable policy.
1) Was a response received?—As set forth in the description of the simple welcome page, an intermediate page may have a watch-dog timer that expires if no input is received from the web viewer within a particular time limit. If no response is received, this may be a non human entity that does not know how to deal with the intermediate page.
2) How fast was the response input?—If a response is received nearly instantaneously then the web viewer may be a computer program since humans generally cannot react instantaneously.
3) What is the content of the response?—If the response from the web viewer is not logical then the response may be from a computer program. For example, if the web viewer is requested to enter a date of birth and the response indicates that the web viewer is less than two years old, such an illogical response may indicate a response from a non human entity. Similarly, if the response consisted of a mouse-click in an inappropriate region, the web viewer may be from a non human entity.
4) What is the time of day?—Is this the middle of the night? If so, this might be a computer program.
5) What is the advertiser's preference?—Does the advertiser wish to have likely non human entities ignored or does the advertiser want all accesses to be serviced.
6) What is the current traffic load?—If the current traffic load is high there may be a preference to ignore entities that are suspicious and may be non human in order to reduce the traffic load.
7) Recent suspicious activity?—Has there been suspicious activity lately? If so, does this access appear similar to the suspicious activity?
8) Internet geograhic origin—Is this request from an IP address that has previously been determined to be a non human entity? Is this request from an IP address range owned by an ISP that allows spammers and/or other unethical conduct?
9) Physical geographic origin—Is this request being received from a country that the advertiser does not serve? Is the country known for harboring spammers and/or other unethical conduct?

Note that all or subsets of these factors may be combined in their consideration. For example, the time of day may be combined with the physical geographic origin in order to determine if it is the middle of the night for that geographic location.

As set forth above, the output of the adjustable policy may comprise two output determinations: a judgment as to whether the web viewer is human or not and a determination of how to proceed with the request. The human or non-human judgment should be recorded along with the other information about the link that was stored in step 220.

Step 285 illustrates a decision step that implements the outcome of the determination of how to proceed. If adjustable policy decides that the web viewer is likely to be a non human entity and does not wish to waste resources on that non human entity, the system may simply ignore the web viewer. Note that non human entities should not always be ignored since
1) Doing so would inform the programmer of the non human browsing program that adjustments are needed to the program in order to get through the intermediate web page,
2) This judgment is only probabilistic and is not a final authoritative determination as to whether the activity is robotic.

If the adjustable policy determines that the web viewer is likely to be a human or the adjustable policy determines that the web viewer may be a non human entity but wishes to serve the web page anyway, the system proceeds to step 290 wherein the system redirects the web viewer's web browser to the advertiser's designated web site. If the intermediate page collected any information from the web viewer (such as demographic information), the system may pass that collected information along to the advertiser's site in a cookie or as part of the URL used to access the advertisers web site. Furthermore, the web viewer's selection on the intermediate page may direct the web viewer to a specific area of the advertiser's web site as set forth with reference to FIGS. 4B and 4C.

In one embodiment of the present invention, the adjustable policy may request that additional information be collected from the web viewer in order to make a more accurate determination of whether the web viewer is a human or non human entity. Thus, as illustrated with dashed lines, the system may proceed to step 270 to select another intermediate web page that will be used to obtain additional information from the web viewer. The system will then repeat the steps of displaying the newly selected intermediate web page (step 250), analyzing and storing the web viewer's response to the newly selected web page with the adjustable policy (step 280), and implementing the output of the adjustable policy determination (step 285).

### Policy Based Intermediate Page Injection for Click Fraud Testing

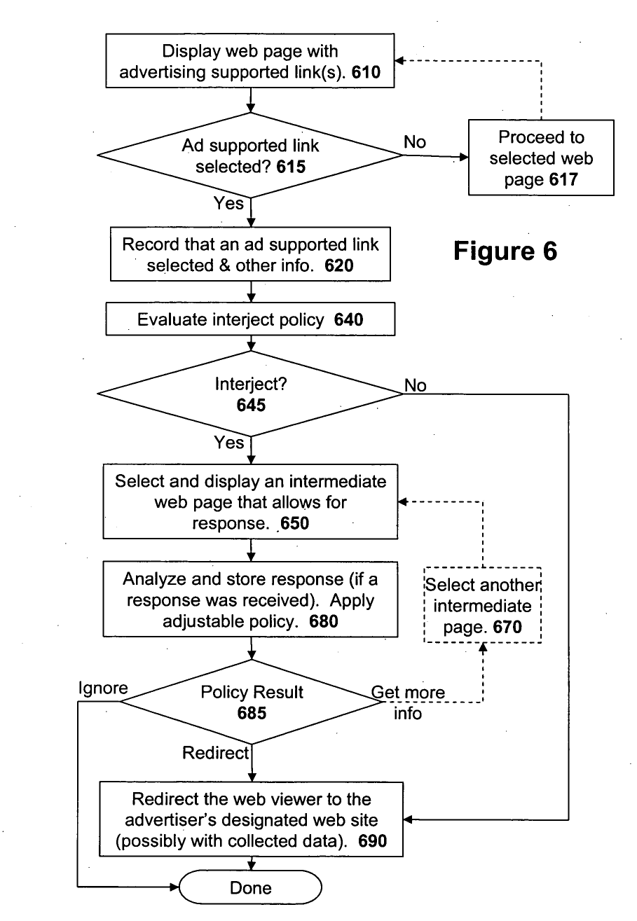

Consumers that browse the web can be notoriously impatient and easily alienated. Some researchers have indicated that if you cannot display a web page within seven seconds then you will lose a large number of web viewers browsing your web site. Thus, one may not wish to interject an intermediate web page every time that a web viewer selects an advertising link. FIG. 6 illustrates an alternative embodiment of using intermediate web pages for click-fraud detection that reduces the amount of intermediate pages displayed to web viewers.

As illustrated in FIG. 6, the initial steps of displaying a web page with advertising supported links (step 610), processing web viewer input (step 615), and handling the web viewer input (steps 617 and 620) are the same as set forth in the previous embodiment of FIG. 2. However, after the system records that an advertisement supported link has been selected, the system proceeds to step 640 wherein the system evaluates an adjustable interject policy.

The adjustable interject policy determines whether or not an intermediate web page should be displayed to the web viewer for the purpose of helping to determine if the web viewer is a human or non human entity. By only occasionally interjecting an intermediate page, only few of the web viewers that access the web site will be subjected to the intermediate web page that may annoy the web viewer.

The adjustable interject policy may consider a large number of different factors depending on what information is collected from the web viewer and the desires of the advertiser. The following is a list of factors that may be considered and possibly manners to consider these factors. However, this list is not exhaustive as other additional factors may be considered with an adjustable interject policy.
1) Random Check?—An intermediate page may be randomly interjected to test a statistical sampling of web.
2) What is the advertiser's preference?—An advertiser may specify that they want no testing, that every web viewer be tested, some percentage of web viewers tested, or some other method of determining how often to interject.
3) What is the current traffic load?—If the current traffic load is high there may be a preference to not introduce the additional traffic caused by the intermediate page. Alternatively, a high traffic load may indicate suspicious activity such that it may be desirable to test.
4) Recent suspicious activity?—Has there been suspicious activity lately? If so, then perhaps a higher number of web viewers should be tested than normally. Once the suspicious activity ceases, the system may return to a normal testing amount.
5) Internet geographic origin—Is this request from an IP address that has previously been determined to be a non human entity? Is this request from an IP address range owned by an ISP that allows spammers and/or other unethical conduct? Such suspicious Internet addresses should probably be tested.
6) Physical geographic origin—Is this request being received from a country that the advertiser does not serve? Is the country known for harboring spammers and/or other unethical conduct? Such suspicious geographic originating requests should probably be tested.
7) Are other click fraud indicators or rules raise the level of suspicion regarding this web viewer?

After evaluating the adjustable interject policy at step 640, the system either interjects with an intermediate web page or not. If the system opts not to interject, the system proceeds down to step 690 to redirect the web viewer to the advertiser's designated web site.

However, if the adjustable interject policy determines that the web viewer should be tested, the system proceeds to step 650 wherein the systems selects and displays an intermediate web page for testing the web viewer. The interject policy may specify a specific type of intermediate page to display to the web viewer. For example, if the interject policy determines that the internet address is very likely to be associated with computer program that browses the web, the interject policy may specify that a CAPTCHA intermediate page be selected. The display of the intermediate web page at step 650 and the testing of the web viewer's response to the intermediate web page at step 680 occur in the same manner as set forth with reference to FIG. 2.

### Data Collection Post-Processing

The system of the present invention collects a large amount of data on web viewers that select advertising supported links. Specifically, step 620 records information about the web viewer and the advertisement link that was selected. Furthermore, step 680 analyzes the web viewer's response to an intermediate web page (if displayed) and whether the adjustable policy believes that this is a human or non human entity. With all of this available information, machine learning algorithms may be used to post-process this data in order to build a better system for determining whether a web viewer is a human or non human entity.

For example, in one embodiment the collection of data on how web viewers interact with an intermediate page is examined with a machine learning algorithm that performs Bayesian Inference. In such an embodiment, a Bayesian classifier may be created in order to help identify non human web viewer entities.

The foregoing has described a number of techniques for determining fraudulent Internet-based advertisement viewings. It is contemplated that changes and modifications may be made by one of ordinary skill in the art, to the materials and arrangements of elements of the present invention without departing from the scope of the invention.

1. A method of testing traffic on the World Wide Web, said method comprising;
displaying an advertising supported link on a first web page;
recording a selection of said advertising supported link by a web viewer;
displaying an intermediate web page to said web viewer;
analyzing a response (if any) received from said web viewer in response to said intermediate web page; and
applying an adjustable testing policy to at least one factor, said at least one factor including said response, to determine if said web viewer is a human entity.

2. The method of testing traffic on the World Wide Web as set forth in claim 1 wherein said at least one factor further comprises a speed of said response received from said web viewer.

3. The method of testing traffic on the World Wide Web as set forth in claim 1 wherein said at least one factor further comprises a geographic location of said web viewer.

4. The method of testing traffic on the World Wide Web as set forth in claim 1 wherein said at least one factor further comprises an internet address of said web viewer.

5. The method of testing traffic on the World Wide Web as set forth in claim 1 wherein said at least one factor further comprises a time of day.

6. The method of testing traffic on the World Wide Web as set forth in claim 1 wherein said at least one factor further comprises a content of said response.

7. (canceled)

8. The method of testing traffic on the World Wide Web as set forth in claim 1 wherein said intermediate web page collects demographic information about said web viewer.

9. (canceled)

10. The method of testing traffic on the World Wide Web as set forth in claim 1 wherein said intermediate web page comprises a complex task for said web viewer.

11. The method of testing traffic on the World Wide Web as set forth in claim 8 wherein said complex task comprises a CAPTCHA.

12. The method of testing traffic on the World Wide Web as set forth in claim 1 wherein said intermediate web page restores said web viewer to select a particular location within an image on said intermediate web page.

13. A method of testing traffic on The World Wide Web, said method comprising;
displaying an advertising supported link on a first web page;
recording a selection of said advertising supported link by a web viewer;
evaluating an adjustable interject policy, if said adjustable interject policy determines that an interject should occur then performing the substeps of displaying an intermediate web page to said web viewer;
analyzing a response (if any) received from said web view in response to said intermediate web page; and
applying an adjustable testing policy to at least one factor, said at least one factor including said response, to determine if said web viewer is a human entity.

14. (canceled)

15. (canceled)

16. The method of testing traffic on the World Wide Web as set forth in claim i3 where said adjustable interject policy considers a time of day.

17. (canceled)

18. (canceled)

19. The method of testing traffic on the World Wide Web as set forth in claim 13 wherein said intermediate web page collects demographic information about said web viewer.

20. (canceled)

21. The method of testing traffic on the World Wide Web as set forth in claim 11 wherein said intermediate web page comprises a complex task for said web viewer.

22. (canceled)

23. The method of testing traffic on the World Wide Web as set forth in claim 13 wherein said intermediate web page requires said web viewer to select a particular location within an image on said intermediate web page.

24. The method of testing traffic on the World Wide Web as set forth in claim 11 wherein said adjustable interject policy considers whether recent suspicious activity has occurred.

25. A system of testing traffic on the World Wide Web, said system comprising:
a web server displaying an advertising supported link on a first web page to a web viewer, said web server displaying an intermediate web page to said web viewer in response to said user's selection of said advertising supported link;
a testing server, said testing server analyzing a response (if any) received from said web viewer in response to said intermediate web page with an adjustable testing policy to at least one factor, said at least one factor including said response, to determine if said web viewer is a human entity.

26. The system of testing traffic on the World Wide Web as set forth in claim 25 wherein said intermediate web page requires said web viewer to select a particular location within an image on said intermediate web page.

27. The system of testing traffic on the World Wide Web as set forth in claim 26, wherein said intermediate web page comprises a complex task for said web viewer.

28. The system of testing traffic on the World Wide Web as set forth in claim 25 wherein said adjustable interject policy considers whether recent suspicious activity has occurred.
